(19) United States
(12) Patent Application Publication
(10) Pub. No.: US 2026/0241327 A1
(43) Pub. Date: Aug. 20, 2026

(54) DYNAMIC ADSORPTION AND DESORPTION SYSTEM

(71) Applicant: Mosaic Materials, Inc., Alameda, CA (US)

(72) Inventors: Dustin Kraft, Houston, TX (US); Paul Cody, Houston, TX (US); Steven Craig Russell, The Woodlands, TX (US); Olaf Stallmann, Essenheim (DE)

(21) Appl. No.: 19/057,035

(22) Filed: Feb. 19, 2025

(51) Int. Cl. B01D 53/06

(52) U.S. Cl. CPC B01D 53/06; B01D 2253/342; B01D 2257/504

(57) ABSTRACT

A system including a set of sorbent structures and at least a second set of sorbent structures, each sorbent structure in the set of sorbent structures being linked to at least one adjacent sorbent structure in the set of sorbent structures and being configured to retain a sorbent. The sorbent structures being configurable between an extended configuration and a folded configuration without unlinking a sorbent structure from the at least one adjacent sorbent structure. The sorbent structures in the sets are coordinated to be transported and collapsed into a shared vessel configured to perform a desorption process. The set of sorbent structures are coordinated to be transported and un-collapsed out of the vessel subsequent to the desorption process. Each of the sorbent structure set and the at least the second set of sorbent structure set is not integrally linked to the vessel.

### BACKGROUND

Various manufacturing and chemical systems include the use of sorbents to remove gas(es), vapor(s), or a mixture thereof from a fluid via adsorption. For example, adsorption systems such as carbon capture systems may capture carbon dioxide via adsorption with sorbent(s). The sorbents may then be fed to a desorption system to remove the gas(es), vapor(s), or the mixture thereof from the sorbent. Improvement(s) in the adsorption and desorption systems may be desirable.

### SUMMARY

An embodiment of a system including a set of sorbent structures and at least a second set of sorbent structures, each sorbent structure in the set of sorbent structures being linked to at least one adjacent sorbent structure in the set of sorbent structures and being configured to retain a sorbent. The set of sorbent structures being configurable between a first extended configuration and a second folded configuration without unlinking a sorbent structure from the at least one adjacent sorbent structure. The set of sorbent structures and the at least the second set of sorbent structures are coordinated to be transported and collapsed into a shared vessel, the shared vessel being configured to perform a desorption process, wherein the set of sorbent structures and the at least the second set of sorbent structures are coordinated to be transported and un-collapsed out of the vessel subsequent to the desorption process. Each of the sorbent structure set and the at least the second set of sorbent structure set is not integrally linked to the vessel.

An embodiment of a method including extending a set of sorbent structures to a first extended configuration during an adsorption phase, collapsing the set of sorbent structures into a second folded configuration, positioning the collapsed set of sorbent structures in a receiving void of a desorption chamber and beginning a desorption phase of operations while the collapsed set of sorbent structures are within the receiving void. The receiving void is smaller than at least one dimension of the set of sorbent structures in the first extended.

### BRIEF DESCRIPTION OF THE DRAWINGS

The following descriptions should not be considered limiting in any way. With reference to the accompanying drawings, like elements are numbered alike:

FIGS. 1A and 1B are schematic diagrams showing a foldable sorbent adsorption and desorption system according to one or more embodiments;

FIGS. 2A and 2B are schematic diagrams showing a foldable sorbent adsorption and desorption system according to one or more embodiments;

FIG. 3 is a schematic diagram showing a foldable sorbent adsorption and desorption system according to one or more embodiments;

FIG. 4A-4C is a schematic diagram of the one or more embodiment of FIG. 3 at a particular moment in an adsorption and desorption process;

FIG. 5A-5C is a schematic diagram of the one or more embodiment of FIG. 3 at a particular moment in an adsorption and desorption process;

FIG. 6A-6C is a schematic diagram of the one or more embodiment of FIG. 3 at a particular moment in an adsorption and desorption process;

FIG. 7A-7C is a schematic diagram of the one or more embodiment of FIG. 3 at a particular moment in an adsorption and desorption process;

FIG. 8A-8C is a schematic diagram of the one or more embodiment of FIG. 3 at a particular moment in an adsorption and desorption process;

FIG. 9A-9C is a schematic diagram of the one or more embodiment of FIG. 3 at a particular moment in an adsorption and desorption process; and

FIG. 10A-10C is a schematic diagram of the one or more embodiment of FIG. 3 at a particular moment in an adsorption and desorption process.

### DETAILED DESCRIPTION

A detailed description of one or more embodiments of the disclosed apparatus and method are presented herein by way of exemplification and not limitation with reference to the Figures.

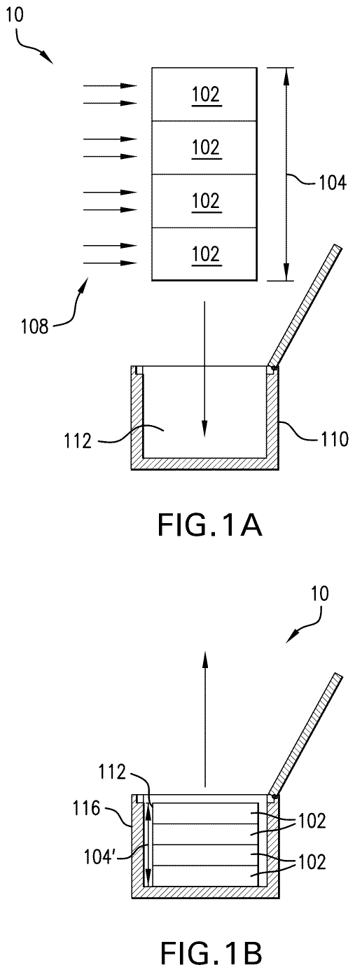

FIG. 1A illustrates a non-limiting embodiment of a foldable sorbent adsorption and desorption system (the system 10) in an adsorption phase (FIG. 1A) and a desorption phase (FIG. 1B). In one example, the system 10 is part of a carbon capture system. The system 10 more than one set of adsorption structures (sorbent structures 102) arranged in a chain, or otherwise connected in a linear or semi-linear fashion. In some examples, the individual sorbent structures 102 may be capable of decoupling from the set of sorbent structures 102 for replacement, repair, or any other reason and subsequently being recoupled to the set of sorbent structures 102. In alternative examples, the individual sorbent structures 102 may be permanently connected to other structures 102 in the set of sorbent structures 102 and replacement or repair of individual sorbent structures 102 will require removing the entire set of sorbent structures 102 from service until the repair or replacement is complete.

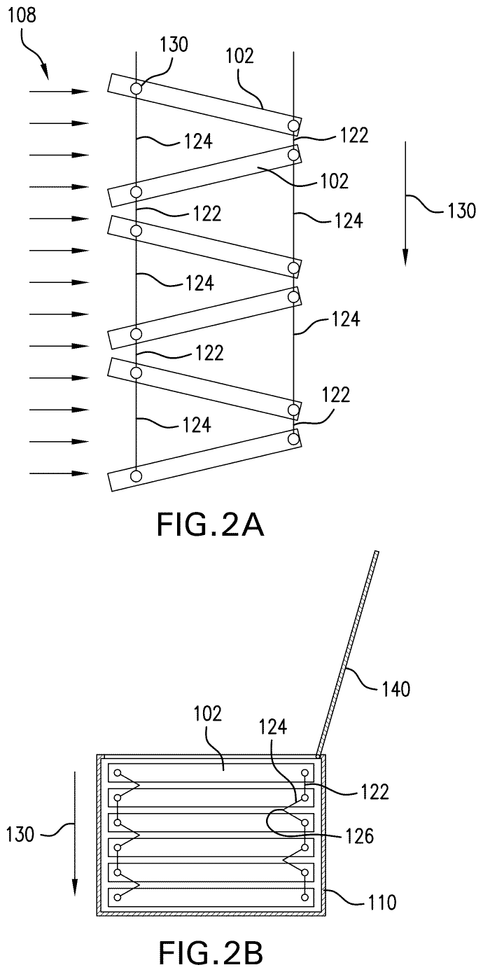

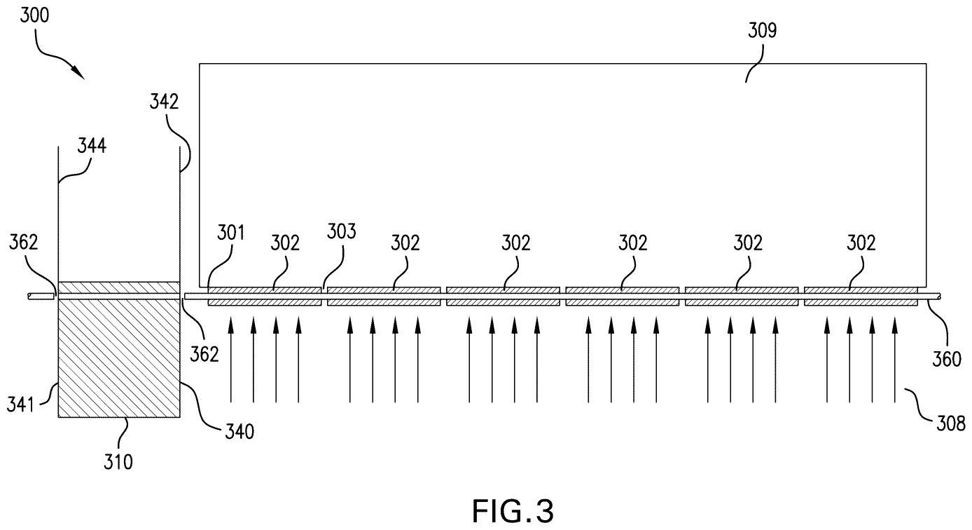

In embodiments according to FIGS. 1A and 1B, during the adsorption phase (FIG. 1A), a sorbent contained in the sorbent structures 102 adsorbs carbon dioxide from an input gas flowing into and through the sorbent structures 102 along a flowpath 108. Each of the sorbent structures 102 is constructed of a frame and a solid sorbent in either a pelletized media, a monolith media or another structured form contained within and supported by the frame. When the sorbent structures 102 include a pelletized media, the sorbent structures 102 are typically arranged at an angle to the flowpath 108 (as demonstrated in the embodiments of FIGS. 2A and 2B). When the sorbent structures 102 include a monolith media, the sorbent structures 102 are typically arranged with openings in the sorbent monolith being as close to normal to a direction of flow of air along the flowpath 102 as possible such that air flows through the solid sorbent monolith is as uninhibited as possible (as demonstrated in the embodiments of FIGS. 3A-11C). These arrangements of structures 102 provides a length 104 of the longest combined dimension of the set of sorbent structures 102.

At the desorption phase (FIG. 1B), carbon dioxide (C02) is desorbed from the sorbent in the sorbent structures 102 within a desorption chamber 110. It is beneficial for the desorption chamber 110 to have as little air as possible to provide a higher purity of removed C02. Maximizing the volume fill of the desorption chamber 110 decreases the amount of air in the desorption chamber 110 during the desorption process. This results in a maximization of potential CO2 production, thereby increasing the output stream purity. Maximizing the volume fill also minimizes the need for a vacuum system or nitrogen purge to remove the air from the receiving void 112 during desorption

The desorption chamber 110 includes a receiving void 112 in which the set of sorbent structures 102 is packed during the desorption phase of operations. The receiving void 112 has a length that is shorter than the corresponding length of the set of sorbent structures 102 in their extended (unfolded) arrangement. In order to fit within the desorption chamber 110, the sorbent structures 102 fold into a folded configuration without disconnecting individual structures 102 from the connected set of sorbent structures 102. The folded configuration of sorbent structures 102 has a length 104 substantially shorter than the unfolded length 104, and sufficiently short that the folded set of sorbent structures 102 fits within the receiving void 112 of the desorption chamber 110. The folded configuration of the sorbent structures 102 in the set of sorbent structures is substantially more compact than the unfolded (extended) configuration.

In some examples, multiple sets of sorbent structures 102 can share a common desorption chamber 110 in the system. Since the adsorption process takes longer than the desorption process, each set of structures 102 are transported in and out of the desorption chamber 110 during a single collective process cycle. In this way, the desorption chamber 110 remains productive over the course of the cycle for improved system efficiency. In this example the combined length of the collapsed sorbent structures 102 can exceed the length of the desorption chamber 110, thereby achieving the same benefits during the desorption phase.

In the non-limiting carbon capture example, the input gas may be atmospheric gas or flue gas from a manufacturing system or a chemical system. However, the input gas may be any gas including gas(es), vapor(s), or a mixture thereof where there is a benefit to removing a portion of the gas (e.g., the C02) from the input gas. Examples of the adsorption and desorption structures and processes will be described in more detail below with respect to FIGS. 2A-10C.

The system 10 disclosed at FIGS. 1A and 1B illustrates an arrangement of solid sorbent beds (sorbent structures 102) able to be configured in a vertical arrangement (FIG. 1A) during the adsorption phase, with the vertical arrangement maximizing adsorption efficiency. The arrangement of solid sorbent beds (sorbent structures 102) can similarly be arranged in the folded configuration (FIG. 1B) during the desorption phase, thereby maximizing a packing density of the sorbent inside the desorption chamber.

With continued reference to FIGS. 1A and 1B, FGS. 2A and 2B illustrate another example embodiment of the system 10 of FIGS. 1A and 1B in which the sorbent structures 102 are interconnected via a set of linkages 122, 124. The linkages 122, 124 are connected to the sorbent structures 102 via connectors 130, and the connectors 130 may include pins, through holes, and any other arrangement by which the linkage 122, 124 is connected to the sorbent structure 102. The linkages 122, 124 are fully extended while in the adsorption phase resulting in a pleated, or ladder, configuration as illustrated in FIG. 2A.

The linkages 122, 124 include a first set of linkages 122 and a second set of linkages 124, with the linkages in the first set of linkages 122 being shorter than the linkages in the second set of linkages 124.

When collapsed into the folded state, as shown in FIG. 2B for the desorption phase, the longer linkages 124 bend or fold, allowing for a stacked horizontal orientation of each sorbent structure 102 in the set of sorbent structures 102. The linkages 122, 124 may be a flexible material (e.g. rope, cable, chain, belt, etc.), a rigid material with a hinge 126 in each longer linkage 124, or a combination thereof. In some examples, any given linkage 124 may be a combination of flexible and rigid materials, with the flexible portion operating to provide the hinge 126. Flexible connections, such as metallic bellows or flexible sheets, are positioned between the short linkages 122 and promote airflow through the individual sorbent beds.

During operation of the system 10, the set of sorbent structures 102 is suspended during an adsorption phase and a gravitational force 130 causes the set of sorbent structures 102 to extend to the ladder or pleat configuration. While in the ladder or pleat configuration, each of the structures 102 is angled relative to the flowpath 108 to transition to the desorption phase, the set of sorbent structures 102 are lowered into the desorption chamber 110, and the gravitational force collapses the sorbent structures 102 into the folded position. Once collapsed and loaded into the desorption chamber 110, a door 140 on the desorption chamber 110 is closed, and the desorption process may begin according to any conventional desorption procedure.

In some alternate examples where one or more of the linkages 122, 124 are rigid linkages, a spring stiffness may maintain the linkages 122, 124 in a normally extended position (the ladder or pleat configuration of FIG. 2A) and the sorbent structures 102 may be motivated into the collapsed position by an actuator or any similar motivational force applied to a frame portion of the structures 102 or applied to the rigid linkages 122, 124.

With continued reference to FIGS. 1A-2B, FIG. 3-11C illustrate another set of embodiments of the system 10 of FIGS. 1A and 2A, with FIG. 3 illustrating a top view of the general structure of a tracked adsorption and desorption system 300 (the system 300), where a set of sorbent structures 302 are suspended on a track 360 in a linear arrangement. In an adsorption phase of operations each of the structures 302 is suspended in an airflow 308 such that air flows through the sorbent structures 302 into a fan adsorb plenum 309. As the air passes through the sorbent structures 302, the sorbent adsorbs C02 from the air.

The track 360 extends into a desorption chamber 310 through a first opening 340. The first opening 340 can be closed by a first door 342, when the structures 302 are fully loaded into the desorption chamber 310. In the illustrated example, the track 360 is a portion of a longer track including multiple adsorption and desorption phases and/or a portion of a continuous track 360 where a set of sorbent structures 302 will continuously travel along a loop through alternating adsorption and desorption phases. In some examples, multiple groups of sorbent structure sets (not shown) are included in the system and the multiple groups of sorbent structure sets share a common desorption chamber 310. In such examples, the desorption chamber 310 includes a second opening 341, closed by a second door 341, opposite the first opening 340, closed by the first door 342 and the sorbent structures 302 exit the desorption chamber 310 through the second door 344 when desorption is complete and the set of structures 302 continues along the track 360.

In order to facilitate the doors 342, 344, the track 360 includes a gap 362 at each door 342, 344 and the structures include features configured to ensure the structures 302 do not get derailed from the track 360 when passing over the gap.

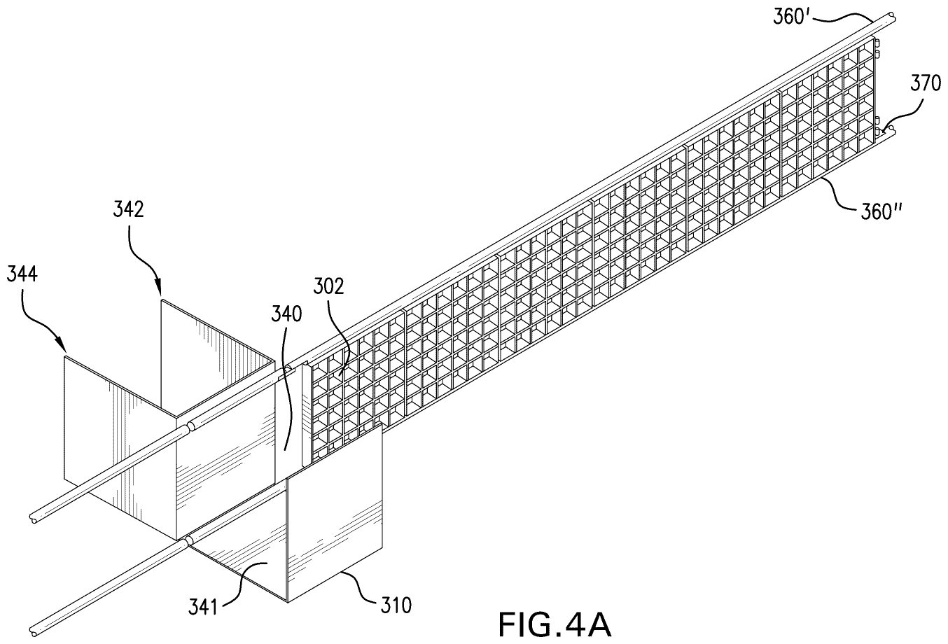

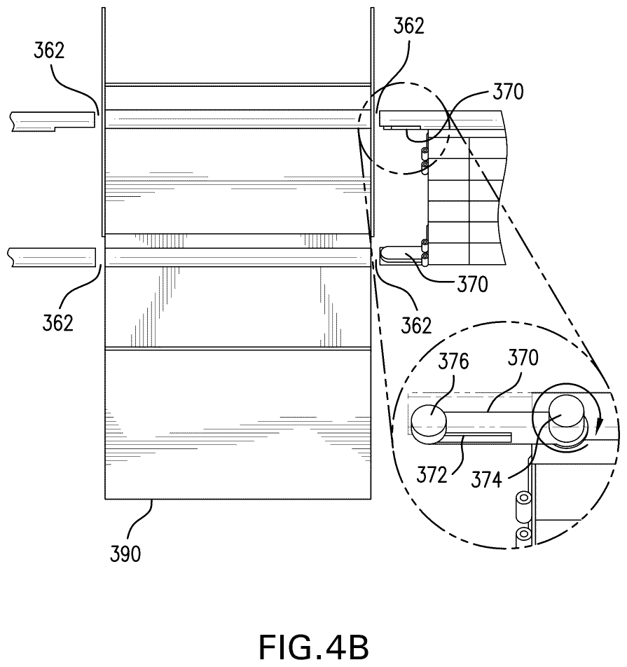

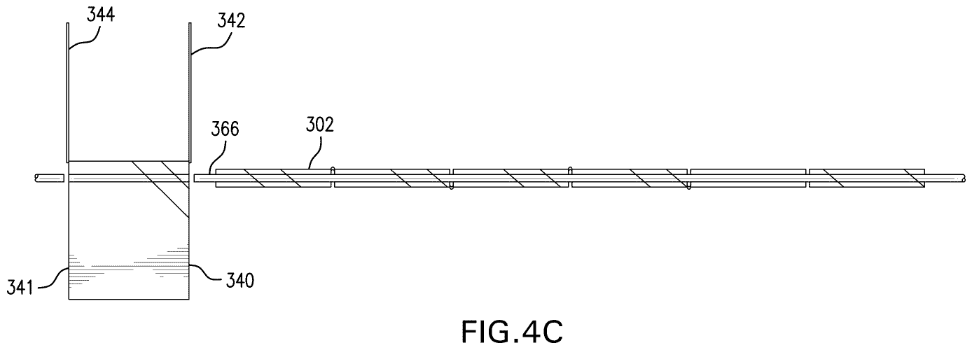

After the adsorption phase is complete, the structures 302 are motivated along the track using any known motivation configuration. As each structure enters the desorption chamber, an end 301, 303 is kicked off the track 360 while the opposite end of the structure is maintained on the track 360. After the first structure 302, adjacent ends 301, 303 of each structure 302 and the subsequent structure 302 are kicked or maintained on the track 360, as show in FIGS. 4A-11C. This arrangement folds the structures into a compact accordion folded position.

When the track 360 is part of a multi-stage looped adsorption and desorption process, multiple sets of structures 302 may be loaded onto the track at the same time, with each set of structures being in a different phase of the adsorption and desorption process.

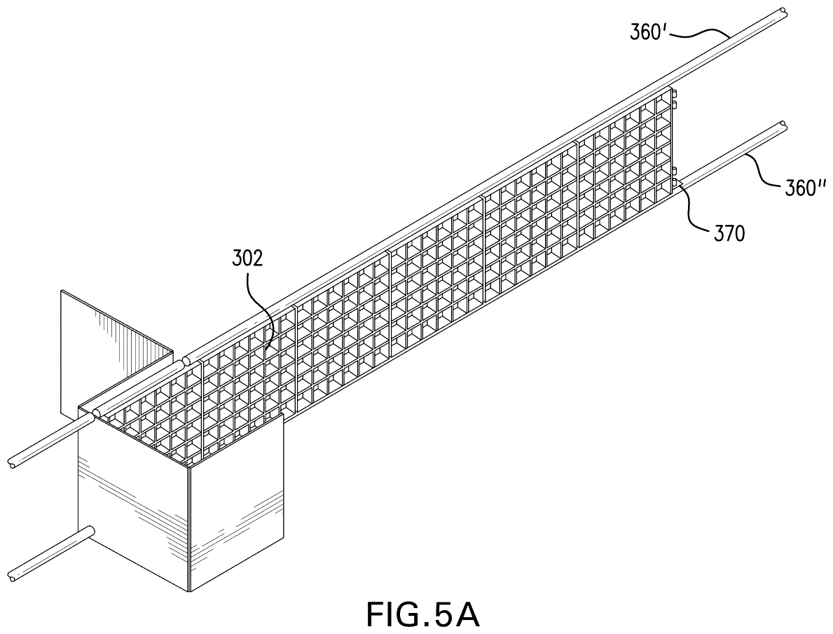

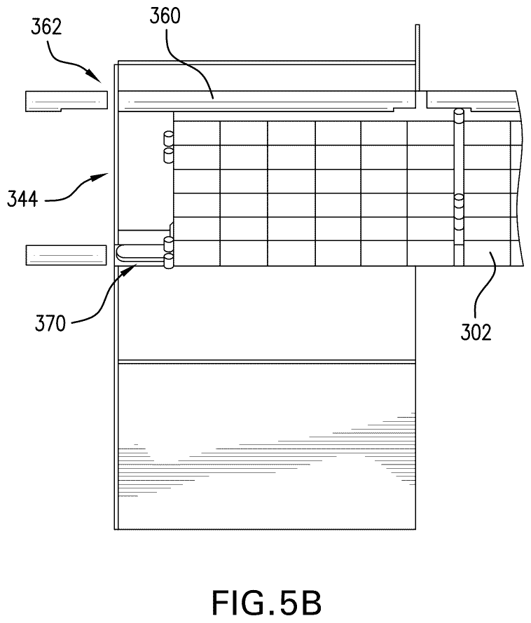

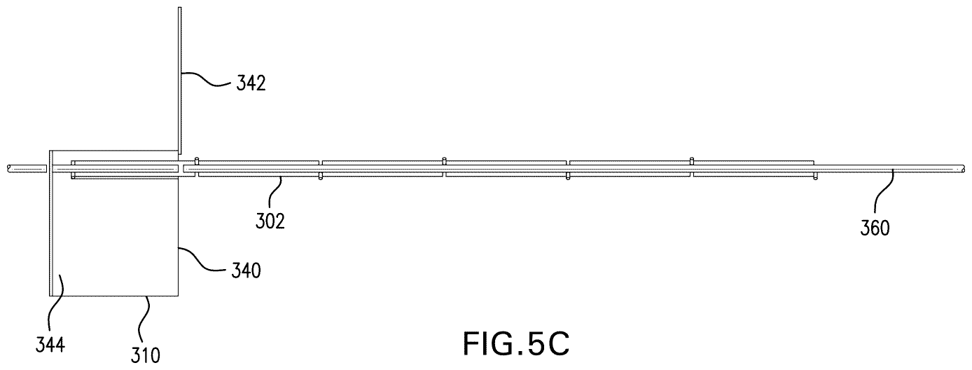

With continued reference to FIG. 3, FIG. 4A illustrates a first isometric view of the system 300 in the adsorption phase (as illustrated in FIG. 3), and FIG. 4B illustrates another isometric view of the desorption chamber portion of the system 300 in the adsorption phase and FIG. 4C illustrates a top view of the system 300 in the adsorption phase. FIGS. 5A-11C include similar views of the same embodiments at different stages of the process, with FIGS. 5A, 6A, 7A, 8A, 9A, 10A, and 11A corresponding to FIG. 4A, FIGS. 5B, 6B, 7B, 8B, 9B, 10B, and 11B corresponding to FIG. 4B, and FIGS. 5C, 6C, 7C, 8C, 9C, 10C, and 11C corresponding to FIG. 4C.

As visible in the isometric views, the track 360 includes a top rail 360′ and a bottom rail 360″. A drive mechanism may drive the structures 302 along the track 360 according to any conventional drive mechanism configuration, including driving along the top rail 360′, driving along the bottom rail 360″, and/or driving along both rails 360′, 360″.

In the examples of FIGS. 3-11C, a forwardmost edge of the forwardmost structure 302 includes a mechanism 370 for derailing and rerailing one end of the structure 302 as the structure 302 enters the chamber 310. The same mechanism 370 is also included at a rearmost structure 302 and provides a similar function. The mechanism 370 may be included on the top rail 360′, the bottom rail 360″, or both rails 360′, 360″. FIG. 4B illustrates the mechanism 370 according to some embodiments. The exemplary mechanism 370 is a rotational key 372 with a torsion spring 374. The rotational key 372 includes a post 376, with the post 376 being configured to be received in the track 360. The post 376 is smaller than the gap 362, allowing the post 376 to leave the track as the structure 302 enters the desorption chamber 310 and to reenter the track 360 as the structure 302 exits the desorption chamber 310.

The torsion spring 374 is connected to the rotational key 372 and maintains the rotational key 372 in a normally tracked configuration. In the normally tracked configuration, absent an outside force, the rotational key 372 is maintained in the position illustrated in FIG. 4B. As with the post 376, the torsion spring 374 extends into the corresponding one of the top rail 360′ or the bottom rail 360″. Unlike the post 376, the torsion spring is sized larger than the gap 362. By including a torsion spring sized larger than the gap 362 the end of the structure 302 including the torsion spring is preventing from derailing as the structure 302 passes over the gaps 362.

After adsorption is complete, a door 344 of the desorption chamber 310 that is farthest from the structures 302 is closed, and the structures 302 are driven along the track 360 until the first structure 302 is within the desorption chamber, as shown in FIGS. 5A, 5B and 5C. While in this position, the rotational key 370 initially makes contact with the door 344.

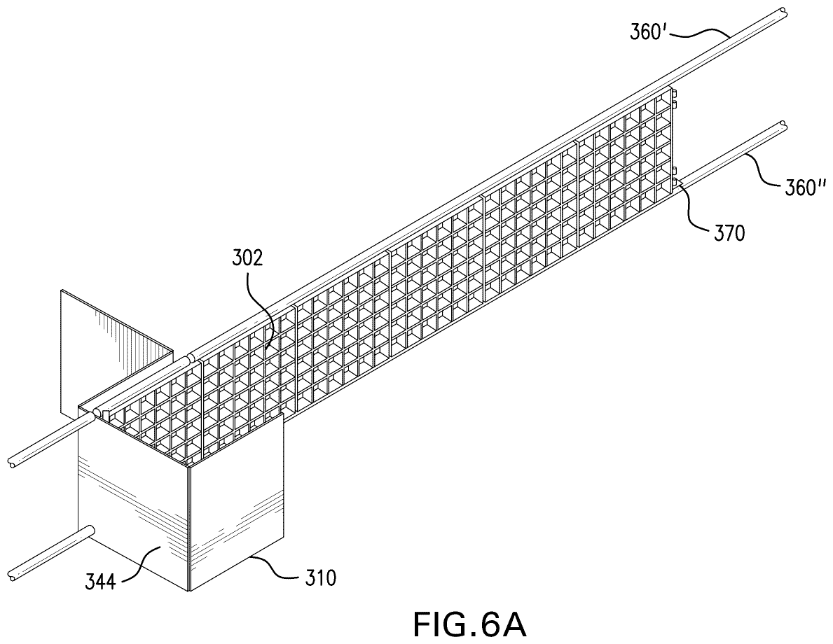

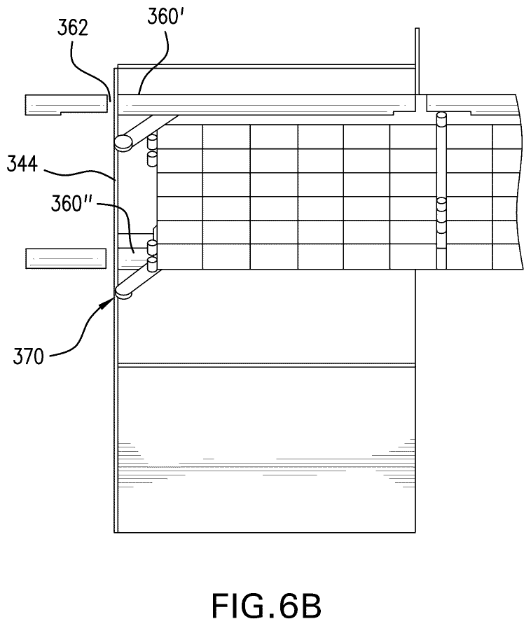

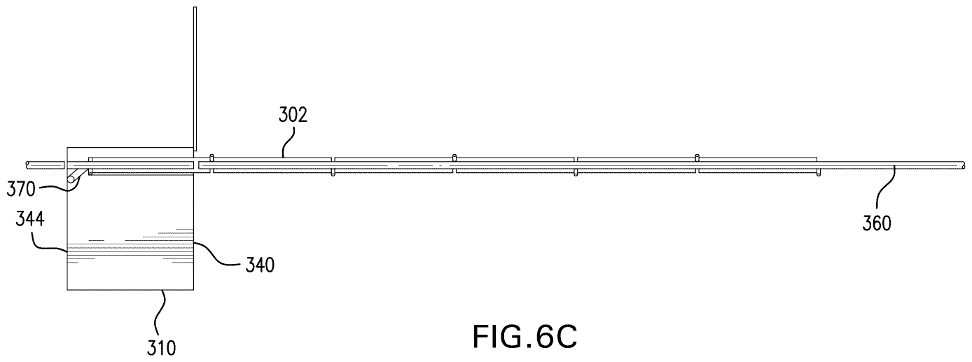

Continued driving of the structures 302 along the track 360 after the rotational key 370 has made contact with the door causes the rotational key 370 to kick out from the track 360 as shown in FIGS. 6A, 6B and 6C.

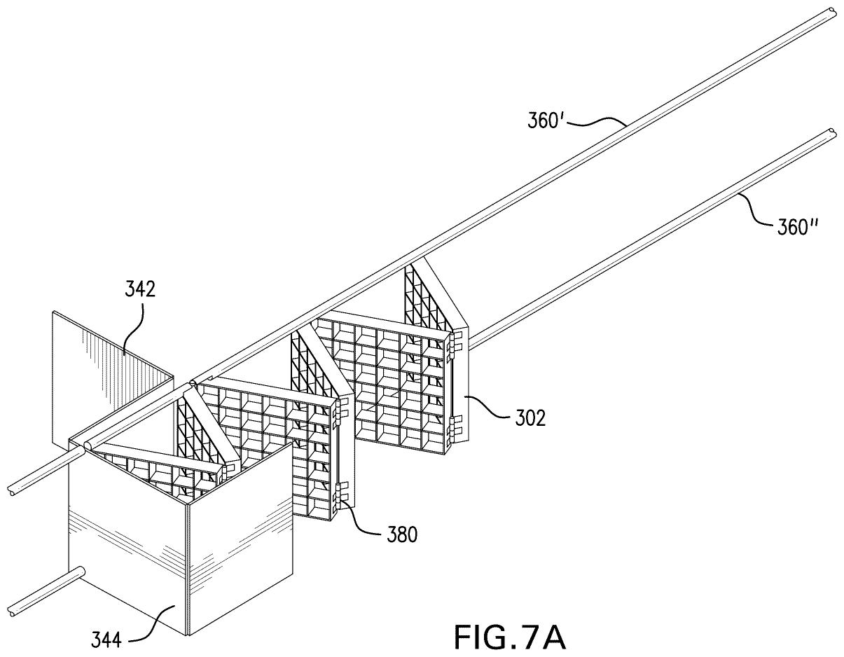

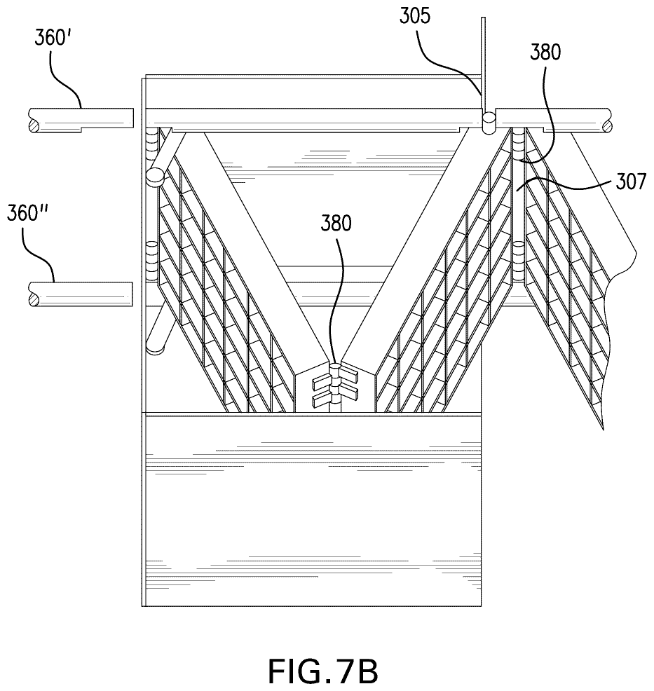

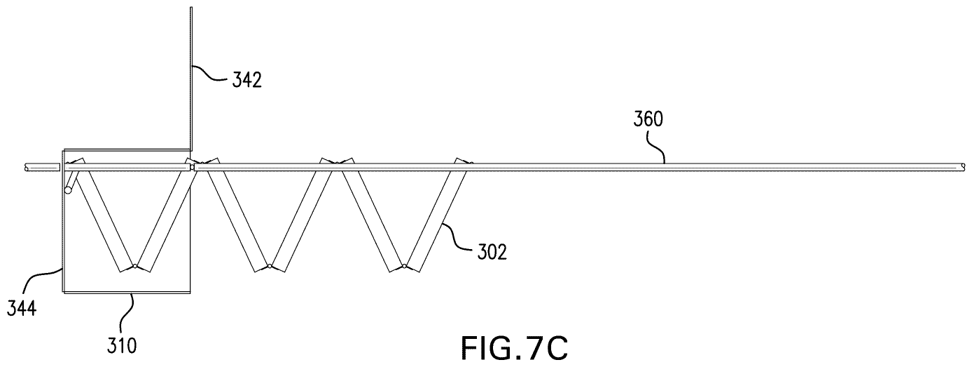

As the structures 302 continued to be driven along the track, the door 344 blocks the forwardmost structures 302 from continuing to travel, and the kicked out tortional key 370 rotates the forwardmost end of the set of structures 302. The rotation causes the structures 302 to collapse into a folded accordion position as shown in FIGS. 7A, 7B and 7C. Hinges 380 connect the ends of the structures 302, and rear edge of every second structure 302 includes a key 305 in the track 360. The key 305 is sized similar to the torsion spring and prevents the set of structures from becoming fully derailed as the structures 302 are folded.

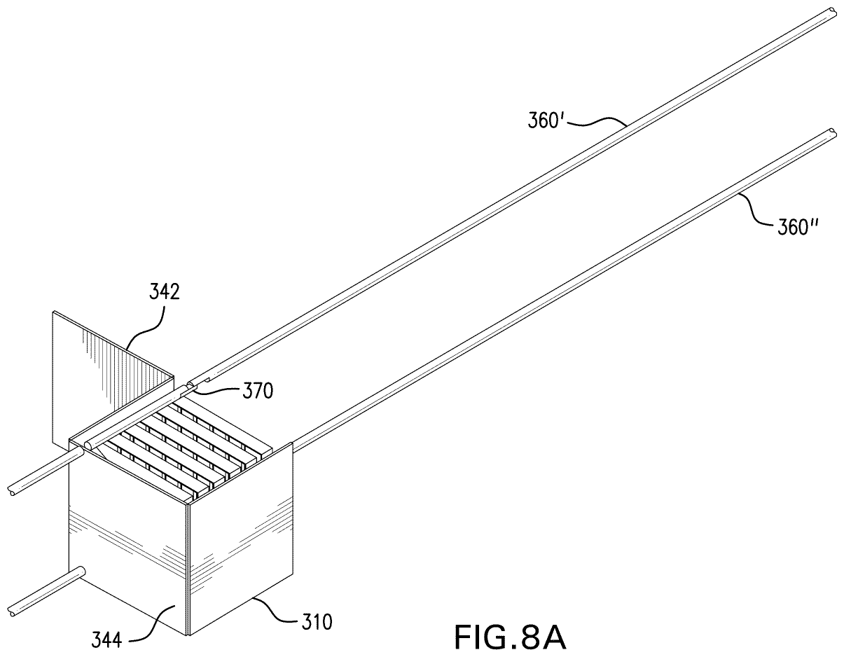

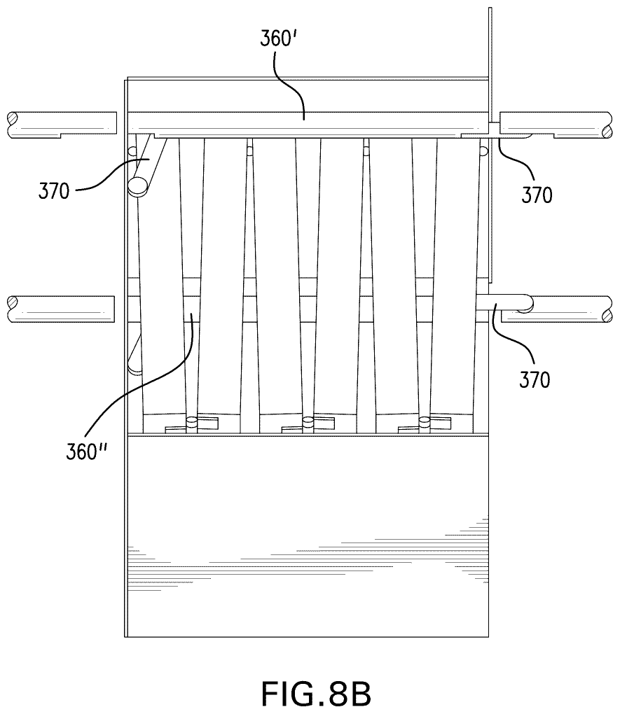

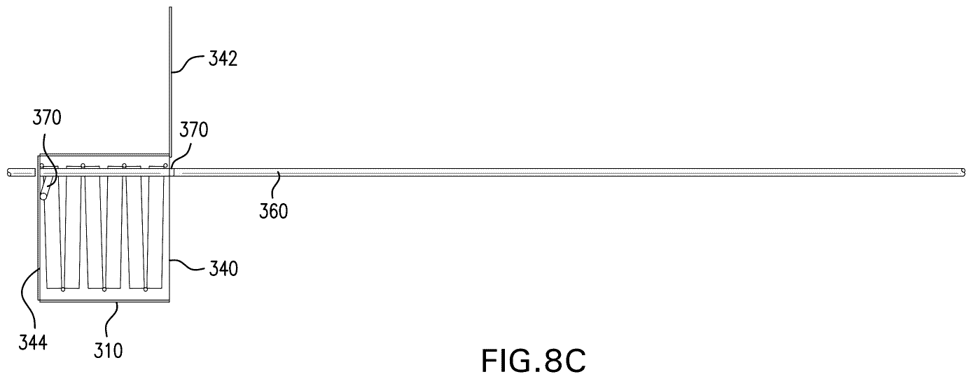

Continued driving of the structures 302 results in a fully folded configuration, shown in FIGS. 8A, 8B and 8C where the structures 302 are now stacked in a configuration that fits within the desorption chamber 310. Once stacked, the first door 342 is closed, resulting in a fully closed desorption chamber 310, and the desorption process begins. As illustrated at FIG. 8B, the closing of the door 342 kicks the rear mechanism 370 out from the normally tracked position.

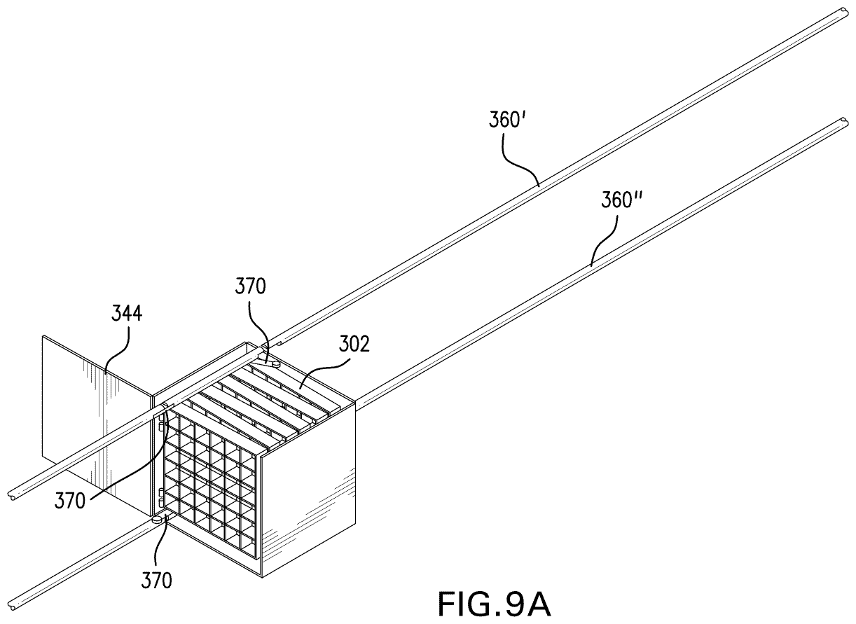

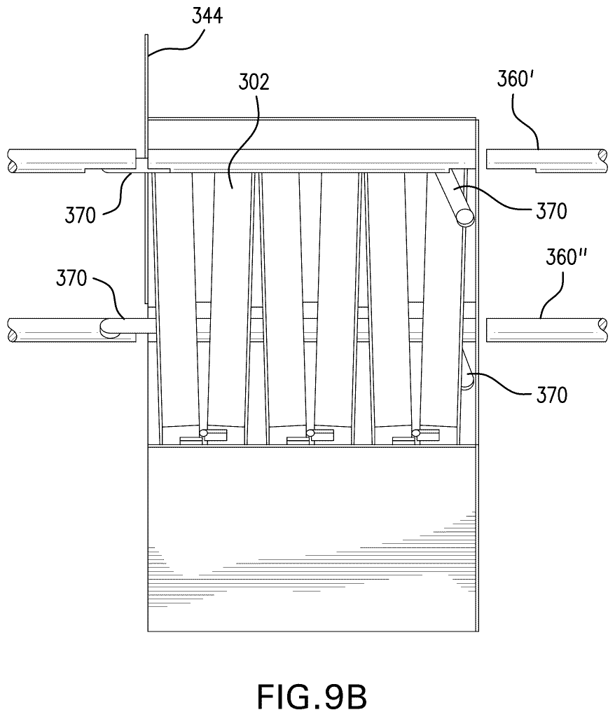

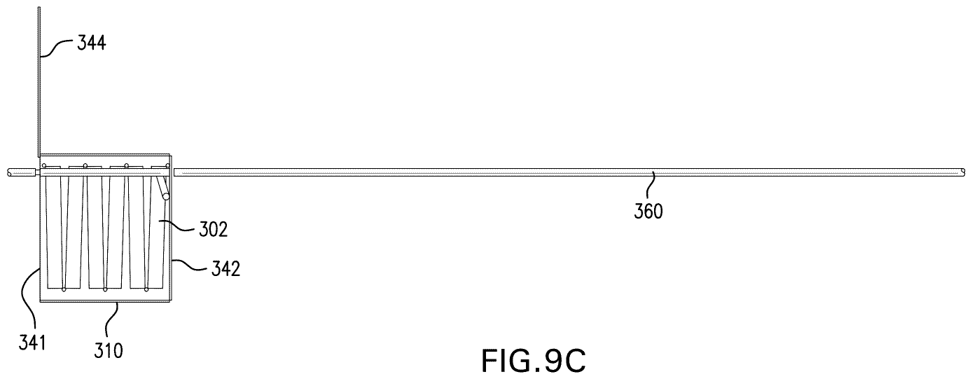

After the adsorption process has been fully completed, the second door 344 is opened, and the torsion spring 374 of the forward most mechanism 370 returns the rotational key 372 of the forward mechanism 370 to the track, as shown in FIGS. 9A, 9B, and 9C.

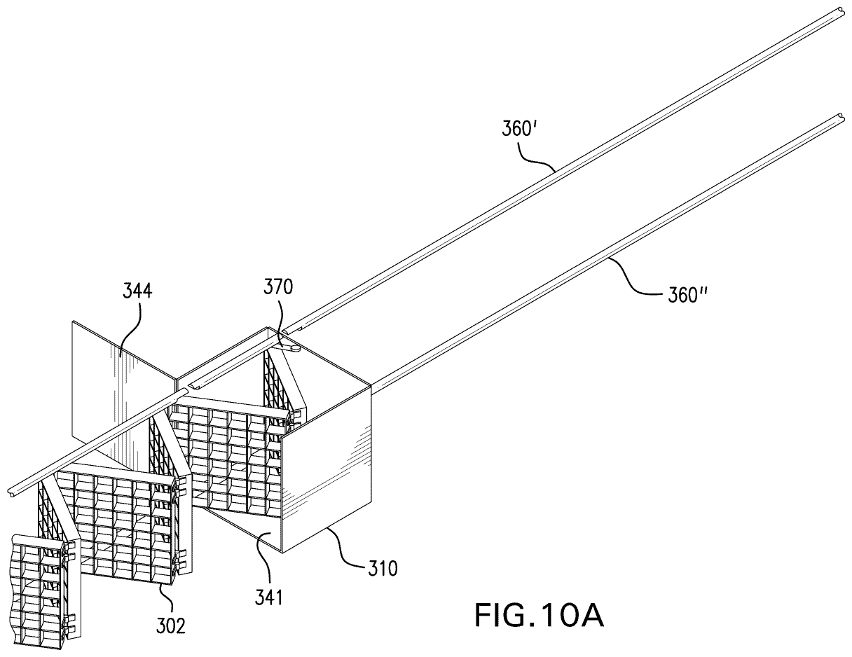

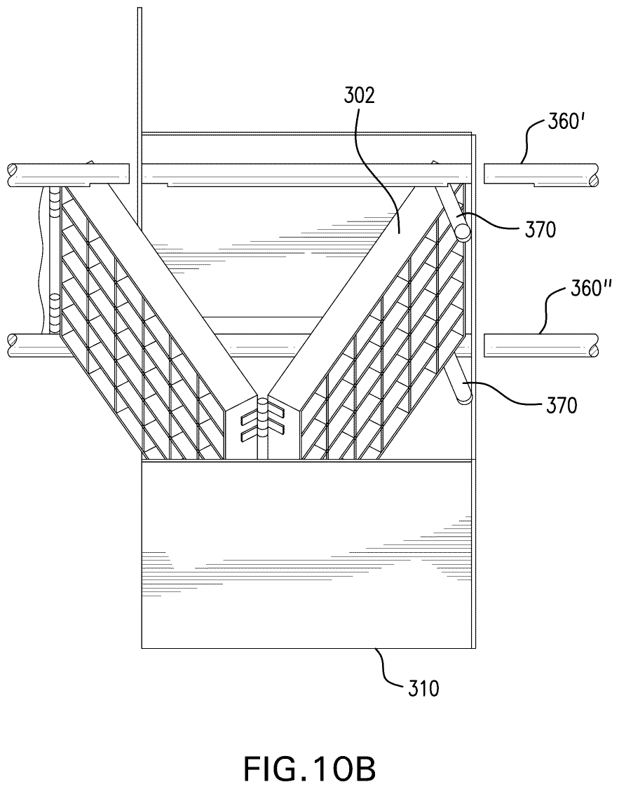

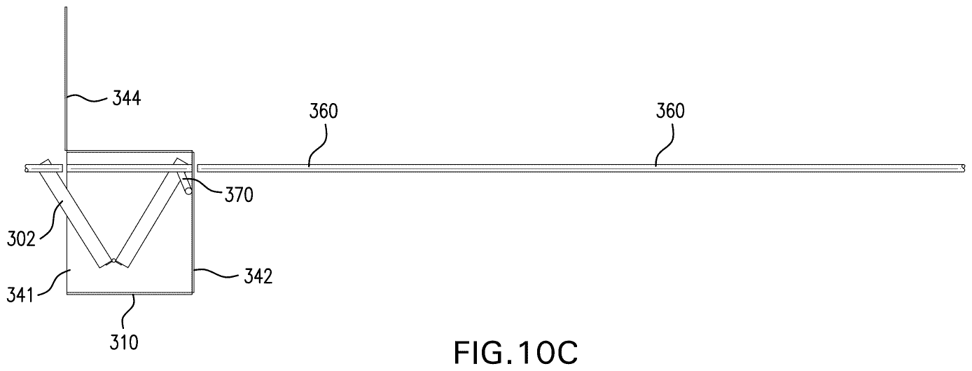

Once the rotational key 372 is returned to the track 360, the driving mechanism begins pulling the structures 302 out from the desorption chamber 310, and the set of structures unfolds as illustrated in FIGS. 10A, 10B and 10C. Once fully unfolded, the structures 302 are driven along the track to the next adsorption chamber.

In one alternate embodiment, instead of looping, the track 360 dead ends in the desorption chamber. In this example, once the desorption is complete, the set of structures are pulled out through the same door 342 by which the set of structures 302 entered the desorption chamber.

The above described example embodiments are non-limiting in nature and variations on the illustrated and described embodiments are included as well.

In one alternate embodiment, the structures 302 may be collapsed into the folded position at an intermediate stage, and the folded structures 302 are then passed into the desorption chamber 310. In such an example, the folding may be achieved entirely or partially via active derailing systems and kickers which remove the appropriate ends of the structures from the track to fold the structures.

It is further appreciated that any disclosed embodiment may be utilized in conjunction with either pelletized sorbents or monolith media sorbents.

Set forth below are some embodiments of the foregoing disclosure:

Embodiment 1: A system including a set of sorbent structures and at least a second set of sorbent structures, each sorbent structure in the set of sorbent structures being linked to at least one adjacent sorbent structure in the set of sorbent structures and being configured to retain a sorbent. The set of sorbent structures being configurable between a first extended configuration and a second folded configuration without unlinking a sorbent structure from the at least one adjacent sorbent structure. The set of sorbent structures and the at least the second set of sorbent structures are coordinated to be transported and collapsed into a shared vessel, the shared vessel being configured to perform a desorption process, wherein the set of sorbent structures and the at least the second set of sorbent structures are coordinated to be transported and un-collapsed out of the vessel subsequent to the desorption process. Each of the sorbent structure set and the at least the second set of sorbent structure set is not integrally linked to the vessel.

Embodiment 2: The system of any other embodiment, wherein the sorbent structures in the set of sorbent structures are configured to retain a pelletized sorbent.

Embodiment 3: The system of any other embodiment, wherein the sorbent structures in the set of sorbent structures are configured to retain a monolithic medium sorbent.

Embodiment 4: The system of any other embodiment, wherein the first configuration is a ladder configuration and wherein each sorbent structure is angled relative to an expected airflow during an adsorption function while in the first configuration.

Embodiment 5: The system of any other embodiment, wherein the set of sorbent structures is maintained in the first extended configuration via a gravitational force while suspended.

Embodiment 6: The system of any other embodiment, wherein the set of sorbent structures is collapsed to the second folded configuration via the gravitational force while not suspended.

Embodiment 7: The system of any other embodiment, wherein each sorbent structure in the set of sorbent structures is connected to at least one adjacent sorbent structure in the set of sorbent structures via a hinge and wherein the set of sorbent structures are interconnected with a rail.

Embodiment 8: The system of any other embodiment, wherein a first sorbent structure in the set of sorbent structures includes a derailing and rerailing mechanism at a first end of the set of sorbent structures.

Embodiment 9: The system of any other embodiment, wherein the derailing and rerailing mechanism comprises a rotational key connected to the first sorbent structure via a torsional spring, the torsional spring maintaining the rotational key in a normally railed position.

Embodiment 10: The system of any other embodiment, wherein the rotational key includes at least a first feature extending from the rotational key into the track, and wherein the at least the first feature is smaller than a gap in the track at an entrance to a desorption chamber.

Embodiment 11: The system of any other embodiment, wherein the torsional spring extends into the track, and wherein the torsional spring is larger than the gap in the track at the entrance to the desorption chamber.

Embodiment 12: The system of any other embodiment, wherein the rail comprises a top rail structure, and a bottom rail structure, and wherein each sorbent structure in the set of sorbent structures is disposed between the top rail structure and the bottom rail structure.

Embodiment 13: The system of any other embodiment, further comprising a desorption chamber including a first desorption door having an open position and a closed position and a receiving void within the desorption chamber, the set of sorbent structures defining at least one dimension larger than a corresponding dimension of the receiving void while the set of sorbent structures is in the first extended configuration and the at least one dimension being less than the corresponding dimension of the receiving void while the set of sorbent structures is in the second folded configuration; and the set of sorbent structures fits fully within the receiving chamber while in the second folded configuration.

Embodiment 14: The system of any other embodiment, further comprising: a desorption chamber including a first desorption door having an open position and a closed position, a receiving void within the desorption chamber, and a second desorption door having an open and a closed position for transporting the set of sorbent structures out of the desorption chamber: the set of sorbent structures defining at least one dimension larger than a corresponding dimension of the receiving void while the set of sorbent structures are in the first extended configuration and the at least one dimension being less than the corresponding dimension of the receiving void while the set of sorbent structures is in the second folded configuration; the set of sorbent structures fits fully within the receiving chamber while in the second folded configuration; and wherein the second door is used to transport the set of sorbent structures out of the vessel in an uncollapsed position.

Embodiment 15: A method including extending a set of sorbent structures to a first extended configuration during an adsorption phase, collapsing the set of sorbent structures into a second folded configuration, positioning the collapsed set of sorbent structures in a receiving void of a desorption chamber and beginning a desorption phase of operations while the collapsed set of sorbent structures are within the receiving void. The receiving void is smaller than at least one dimension of the set of sorbent structures in the first extended.

Embodiment 16: A method of any other embodiment, wherein collapsing the set of sorbent structures comprises unsuspending the set of sorbent structures and allowing a gravitational force to collapse the set of sorbent structures into the second folded configuration.

Embodiment 17: A method of any other embodiment, wherein collapsing the set of sorbent structures comprises motivating the set of sorbent structures along a track and initiating a collapsing action using a mechanism for derailing and retaining one end of the sorbent structures, and wherein the mechanism for derailing and rerailing one end of the sorbent structures comprises a rotational key connected to the first sorbent structure via a torsional spring, the torsional spring maintaining the rotational key in a normally railed position.

Embodiment 18: A method of any other embodiment, wherein the torsional spring maintains the rotational key in the normally railed position using a post extending into a corresponding rail.

Embodiment 19: A method of any other embodiment, wherein each sorbent structure in the set of sorbent structure is linked to at least one adjacent sorbent structure in the set of sorbent structures.

Embodiment 20: A method of any other embodiment, wherein each sorbent structure in the set of sorbent structures retains a sorbent.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. The terms “about”, “substantially” and “generally” are intended to include the degree of error associated with measurement of the particular quantity based upon the equipment available at the time of filing the application. For example, “about” and/or “substantially” and/or “generally” can include a range of ±8% of a given value.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. A system comprising:
a set of sorbent structures, each sorbent structure in the set of sorbent structures being linked to at least one adjacent sorbent structure in the set of sorbent structures and being configured to retain a sorbent;
the set of sorbent structures being configurable between a first extended configuration and a second folded configuration without unlinking a sorbent structure from the at least one adjacent sorbent structure; and
at least a second set of sorbent structures, and wherein the set of sorbent structures and the at least the second set of sorbent structures are coordinated to be transported and collapsed into a shared vessel, the shared vessel being configured to perform a desorption process, wherein the set of sorbent structures and the at least the second set of sorbent structures are coordinated to be transported and un-collapsed out of the vessel subsequent to the desorption process, and wherein each of the sorbent structure set and the at least the second set of sorbent structure set is not integrally linked to the vessel.

2. The system of claim 1, wherein the sorbent structures in the set of sorbent structures are configured to retain a pelletized sorbent.

3. The system of claim 1, wherein the sorbent structures in the set of sorbent structures are configured to retain a monolithic medium sorbent.

4. The system of claim 1, wherein the first configuration is a ladder configuration and wherein each sorbent structure is angled relative to an expected airflow during an adsorption function while in the first configuration.

5. The system of claim 4, wherein the set of sorbent structures is maintained in the first extended configuration via a gravitational force while suspended.

6. The system of claim 5, wherein the set of sorbent structures is collapsed to the second folded configuration via the gravitational force while not suspended.

7. The system of claim 1, wherein each sorbent structure in the set of sorbent structures is connected to at least one adjacent sorbent structure in the set of sorbent structures via a hinge and wherein the set of sorbent structures are interconnected with a rail.

8. The system of claim 7, wherein a first sorbent structure in the set of sorbent structures includes a derailing and rerailing mechanism at a first end of the set of sorbent structures.

9. The system of claim 8, wherein the derailing and rerailing mechanism comprises a rotational key connected to the first sorbent structure via a torsional spring, the torsional spring maintaining the rotational key in a normally railed position.

10. The system of claim 9, wherein the rotational key includes at least a first feature extending from the rotational key into the track, and wherein the at least the first feature is smaller than a gap in the track at an entrance to a desorption chamber.

11. The system of claim 10, wherein the torsional spring extends into the track, and wherein the torsional spring is larger than the gap in the track at the entrance to the desorption chamber.

12. The system of claim 7, wherein the rail comprises a top rail structure, and a bottom rail structure, and wherein each sorbent structure in the set of sorbent structures is disposed between the top rail structure and the bottom rail structure.

13. The system of claim 1, further comprising a desorption chamber including a first desorption door having an open position and a closed position and a receiving void within the desorption chamber, the set of sorbent structures defining at least one dimension larger than a corresponding dimension of the receiving void while the set of sorbent structures is in the first extended configuration and the at least one dimension being less than the corresponding dimension of the receiving void while the set of sorbent structures is in the second folded configuration; and
the set of sorbent structures fits fully within the receiving chamber while in the second folded configuration.

14. The system of claim 1, further comprising:
a desorption chamber including a first desorption door having an open position and a closed position, a receiving void within the desorption chamber, and a second desorption door having an open and a closed position for transporting the set of sorbent structures out of the desorption chamber:
the set of sorbent structures defining at least one dimension larger than a corresponding dimension of the receiving void while the set of sorbent structures are in the first extended configuration and the at least one dimension being less than the corresponding dimension of the receiving void while the set of sorbent structures is in the second folded configuration;
the set of sorbent structures fits fully within the receiving chamber while in the second folded configuration; and
wherein the second door is used to transport the set of sorbent structures out of the vessel in an uncollapsed position.

15. A method comprising:
extending a set of sorbent structures to a first extended configuration during an adsorption phase;
collapsing the set of sorbent structures into a second folded configuration;
positioning the collapsed set of sorbent structures in a receiving void of a desorption chamber, wherein the receiving void is smaller than at least one dimension of the set of sorbent structures in the first extended; and
beginning a desorption phase of operations while the collapsed set of sorbent structures are within the receiving void.

16. The method of claim 15, wherein collapsing the set of sorbent structures comprises unsuspending the set of sorbent structures and allowing a gravitational force to collapse the set of sorbent structures into the second folded configuration.

17. The method of claim 15, wherein collapsing the set of sorbent structures comprises motivating the set of sorbent structures along a track and initiating a collapsing action using a mechanism for derailing and retaining one end of the sorbent structures, and wherein the mechanism for derailing and rerailing one end of the sorbent structures comprises a rotational key connected to the first sorbent structure via a torsional spring, the torsional spring maintaining the rotational key in a normally railed position.

18. The method of claim 17, wherein the torsional spring maintains the rotational key in the normally railed position using a post extending into a corresponding rail.

19. The method of claim 15, wherein each sorbent structure in the set of sorbent structure is linked to at least one adjacent sorbent structure in the set of sorbent structures.

20. The method of claim 15, wherein each sorbent structure in the set of sorbent structures retains a sorbent.
